(19) United States
(12) Patent Application Publication
(10) Pub. No.: US 2002/0135816 A1
(43) Pub. Date: Sep. 26, 2002

(54) Image forming apparatus

(76) Inventor: Masahiro Ohwa, Tokyo-To (JP)

Correspondence Address: Richard L. Schwaab, FOLEY & LARDNER, Washingon Harbour, 3000 K Street, N.W., Suite 500, Washington, DC, 20007-5109, US

(21) Appl. No.: 09/811,765

(22) Filed: Mar. 20, 2001

(51) Int. Cl. H04N 1/04

(52) U.S. Cl. 358/474

(57) ABSTRACT

An image forming apparatus of the present invention has a scanner unit for obtaining text data by scanning a document, an external storage device for, if the text data obtained by the scanner unit are confidential, saving the confidential text data on an attachable/detachable medium, an internal storage device for temporarily saving the confidential text data, a device for deleting the confidential text data after a first predetermined time has elapsed since a point of time when the confidential text data were temporarily saved on the internal storage device, and a control unit for controlling the whole of the image forming apparatus. The internal storage device can be utilized as a device for temporarily saving the confidential document. The system further includes a password registration module for registering user names and passwords. The confidential text data temporarily saved on the internal storage device are transferred to the external storage device on condition that the password inputted by the user is coincident with the password registered in the password registration module. Contents stored on the internal storage device are erased after transferring the confidential text data, and contents stored on the medium are erased if the medium is not pulled out with a predetermined time, thereby further enhancing the security.

### BACKGROUND OF THE INVENTION

1. Field of the Invention

The resent invention relates generally to an image forming apparatus, and more particularly to an image forming apparatus of such a type that a document can be saved on a memory card.

2. Description of the Background Art

What is known as an image forming apparatus has a large-capacity storage device such as a hard disk drive (HDD) or the like for saving the data.

This type of image forming apparatus is not, however, suited for saving confidential information because of a third party easily reading the save data by referring to contents on the HDD.

Further, a version-up of firmware of the image forming apparatus involves connecting the image forming apparatus to a computer and to a network as well, then uploading the firmware and implementing the version-up thereof. This process is vexatious and time-consuming.

Under such circumstances, there is proposed an image forming apparatus (e.g., Japanese Patent Application Laying-Open No. Hei 11-136477) in which a memory card reading/writing device is attached to the image forming apparatus, and the text data are saved on a memory card used only for the user, thereby preventing the data from being read by others and keeping a confidentiality thereof.

In the case of saving the confidential information on the memory card by using this type of image forming apparatus, the user might fail to pull out the memory card from the image forming apparatus after using the memory card as in the case of inputting and printing the text data by use of the memory card and so forth. In such a case, there might be a possibility in which a third party refers to the content on the memory card with the result that the confidential information leaks out.

On the other hand, the user tries to save the document on the memory card, and nevertheless, if a free capacity of the memory card is insufficient, it is impossible of saving the confidential document, with the result that an advantage of using the memory card is lost.

Further, on the occasion of saving or printing the confidential document by use of the memory card, the user must invariably have the memory card, and, if the memory card is not kept available, the user gives up saving or needs to fetch the memory card. In the latter case, it is time-consuming to fetch the memory card, and besides, there still exists the possibility wherein in the meantime the third party refers to the confidential information, resulting in the leak-out thereof.

### SUMMARY OF THE INVENTION

It is a primary object to provide an image forming apparatus capable of sufficiently keeping the confidentiality even if a user forgets to have a memory card or a capacity thereof is insufficient in the image forming apparatus of such a type as to save text data by using the memory card.

To accomplish the above object, according to a first aspect of the present invention, an image forming apparatus comprises a scanner unit for obtaining text data by scanning a document, an external storage device for, if the text data obtained by the scanner unit are confidential, saving the confidential text data on an attachable/detachable medium, an internal storage device for temporarily saving the confidential text data, a device for deleting the confidential text data after a first predetermined time has elapsed since a point of time when the confidential text data were temporarily saved on the internal storage device, and a control unit for controlling the whole of the image forming apparatus.

According to a second aspect of the present inventions an image forming apparatus comprises a scanner unit for obtaining text data by scanning a document, an external storage device for, if the text data obtained by the scanner unit are confidential, saving the confidential text data on an attachable/detachable medium, an internal storage device for temporarily saving the confidential text data, a password registration module for registering a user name and a password, and a control unit for temporarily saving the confidential text data on the internal storage device, permitting a transfer of the temporarily saved confidential text data to the external storage device on condition that the password inputted by a user is coincident with a password registered in the password registration module, erasing contents stored on the internal storage device after a first predetermined time has elapsed since the confidential text data were temporarily saved, and erasing contents stored on the medium if the medium is not pulled out within a second predetermined time after transferring the confidential text data.

According to a third aspect of the present invention, a text data handling method in an image forming apparatus, comprises a step of obtaining text data by scanning a document with a scanner unit, a step of, if the text data obtained by the scanner unit are confidential, temporarily storing the confidential text data on an internal storage device, a step of transferring and saving an attachable/detachable medium with the confidential text data stored on the internal storage device through the external storage device, a step of erasing contents stored on the internal storage device after transferring and saving the confidential text data to and on the medium, and a step of executing a process for prompting a user to pull out the medium out of the external storage device.

According to the image forming apparatus and the text data handling method of the present invention, when saving the confidential data on the memory card, even if the memory card is not kept available, the data can be temporarily saved. Therefore, even if unable to save the data on the memory card due to a deficiency in the free capacity of the memory card and if not bringing the memory card, the text data can be saved. Moreover, it is feasible to prevent the user from failing to pull out the memory card, and, if failing to pull out, there decreases a possibility of a leak-out of the information stored on the memory card.

### BRIEF DESCRIPTION OF THE DRAWINGS

The present invention will be explained in depth with reference to the following accompanying drawings, in which:

FIG. 1 is a block diagram schematically showing a system construction of an image forming apparatus of the present invention, and a data flow;

FIG. 2 is an explanatory diagram showing how a CPU performs the control;

FIG. 3 is a flowchart showing how a process is selected depending on a content of the document to be dealt with and on a processing mode;

FIG. 4 is a diagram showing a copy menu screen for specifying a confidential document mode;

FIG. 5 is a diagram showing a process selection screen when the confidential document mode is specified;

FIG. 6 is a flowchart showing a process of saving the text data on the memory card among processes in a confidential document input mode;

FIG. 7 is a flowchart showing a process of saving the text data on a hard disk drive among the processes in the confidential document input mode;

FIG. 8 is a diagram showing a screen for selecting a recording medium for saving the document;

FIG. 9 is a diagram showing a screen for prompting a user to input the document;

FIG. 10 is a diagram showing a screen for notifying that an input of the confidential document to the memory card is finished;

FIG. 11 is a diagram showing an input screen for inputting a user name and a password used for temporarily saving the document on the HDD;

FIG. 12 is a diagram showing a screen when the process of temporarily saving the document on the HDD is finished;

FIG. 13 is a flowchart showing a routine to prevent against failure of pulling out the memory card;

FIG. 14 is a diagram showing a screen for notifying that all the text data on the memory card are erased;

FIG. 15 is an explanatory flowchart showing a process of outputting the confidential text data:

FIG. 16 is a diagram showing a screen for displaying a message for prompting the user to insert the memory card;

FIG. 17 is a diagram showing an example of displaying a thumbnail of effective text data on the memory card;

FIG. 18 is a diagram showing a display of detailed data of the selected document;

FIG. 19 is diagram showing a screen for notifying that a print-out of the confidential document is finished;

FIG. 20 is a diagram showing a screen for notifying that if the memory card is not pulled out within a set time, contents on the memory card are erased;

FIG. 21 is an explanatory flowchart showing a confidential document transfer process;

FIG. 22 is a diagram showing an input screen for inputting the user name and the password used for accessing the HDD in the transfer process;

FIG. 23 is a diagram showing a screen for prompting the user to re-input the user name and the password;

FIG. 24 is a diagram showing a screen for prompting the user to insert the memory card;

FIG. 25 is a diagram showing a screen for notifying that there is no document saved on the HDD;

FIG. 26 is a diagram showing a screen for notifying that the capacity of the memory card is insufficient in the transfer process;

FIG. 27 is a screen showing how the text data are being transferred to the memory card;

FIG. 28 is a diagram showing a screen for notifying that the data transfer is normally finished;

FIG. 29 is a screen for prompting the user to pull out the memory card;

FIG. 30 is a diagram showing a screen for notifying that the contents stored on the memory card are erased in a process to prevent against failure of pulling out the memory card; and

FIG. 31 is a flowchart showing a process if an error occurs during the transfer of the text data to the memory card.

### DESCRIPTION OF THE PREFERRED EMBODIMENTS

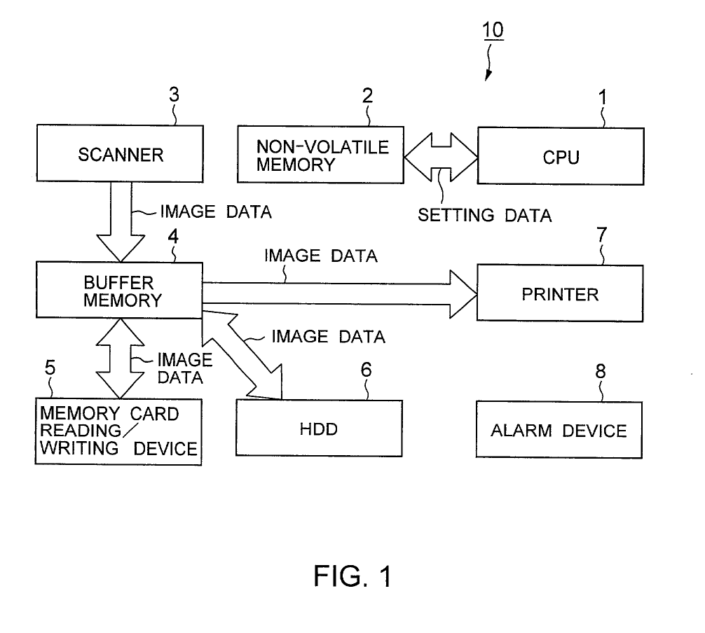

FIG. 1 is a block diagram schematically showing a system construction of an image forming apparatus, and a data flow as well.

This image forming apparatus 10 includes a CPU 1 for controlling the whole system, a non-volatile memory 2 such as an electrically erasable/programmable ROM (EEPROM) in which setting data of the image forming apparatus are stored and from which the data are read out and transmitted to the CPU 1, and a scanner 3 for generating image data by reading a script. The image forming apparatus 10 further includes a buffer memory 4 for temporarily accumulating the image data obtained by the scanner 3 and transferred to the memory 4 itself, a memory card reading/writing device 5 for transferring and receiving the image data between the buffer memory 4 and a memory card for storing confidential documents, a hard disk drive (HDD) 6 for storing contents stored in the buffer memory, a printer 7 for printing the contents stored in and transferred from the buffer memory, and an alarm device 8 for giving an alarm to a user if something abnormal occurs.

Herein, the memory card reading/writing device 5, when storing the confidential documents, writes these confidential documents accumulated in the buffer memory to the memory card and, reversely when outputting the confidential documents, reads the documents from the memory card. These documents are outputted via the buffer memory to the printer 7 and printed by this printer 7.

The hard disk drive 6 reads the text data from the buffer memory 4 and stores the text data, and in turn the text data are read from the HDD 6 and written to the buffer memory 4. Note that the HDD 6 is stored with ordinary documents other than the confidential documents. The alarm device 8 implements no data transmitting/receiving function.

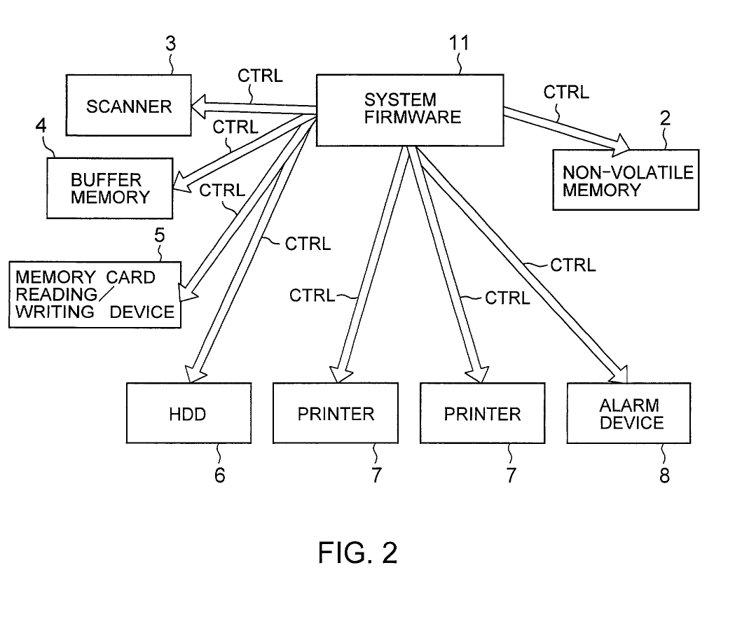

The CPU 1 controls these devices, and the FIG. 2 shows how it controls them. Namely, system firmware implemented by the CPU 1 generically controls the non-volatile memory 2, the scanner 3, the buffer memory 4, the memory card reading/writing device 5, the HDD 6, the printer 7 and the alarm device 8.

The thus configured image forming apparatus 10 incorporates a function of temporarily storing the data in the HDD if the memory card is not provided and automatically erasing the data after a fixed period of time has elapsed, and a function to prevent against failure of pulling out the memory card. A system operation will be described in depth on the premise of processing the confidential document.

According to the present image forming apparatus, a password can be registered beforehand in terms of dealing with the confidential document, and a password issuance menu therefor is prepared. The password registered based on this menu is stored in the non-volatile memory 2.

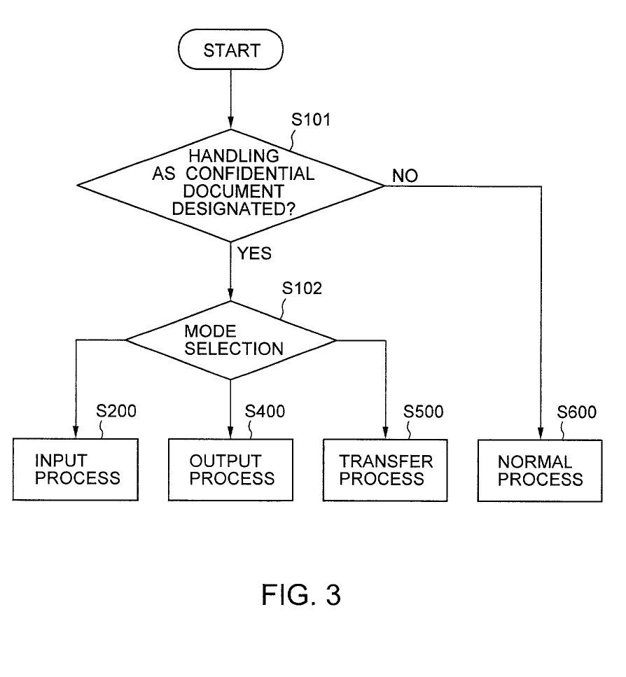

FIG. 3 is a flowchart showing how a process is selected depending on a content of the document to be dealt with and on a processing mode.

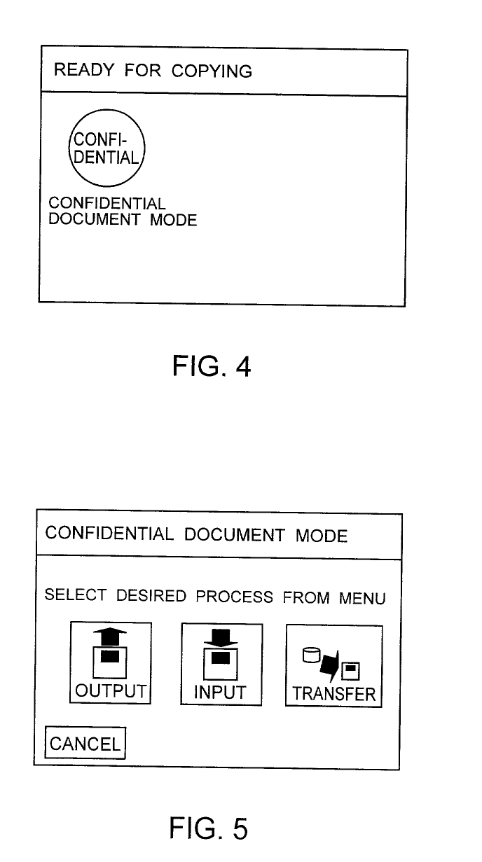

A designation of handling as confidential document is given by selecting a confidential document mode on a normal copy menu shown in FIG. 4 (step S101). Note that FIG. 4 does not illustrate a variety of other selectable copy modes. This confidential document mode may also be selected by inputting a special command and so forth. If not given the indication of dealing with the confidential document, the normal process (S600) is executed.

When specifying the confidential document mode, an output process (S400), an input process (S200) and a transfer process (S500) are selected on the menu screen shown in FIG. 5 (step S102). Herein, the input involves storing the data in the memory card or temporarily storing the data in the HDD, the output involves printing the text data stored in the memory card by the printer, and the transfer involves transferring the text data temporarily stored in the HDD to the memory card.

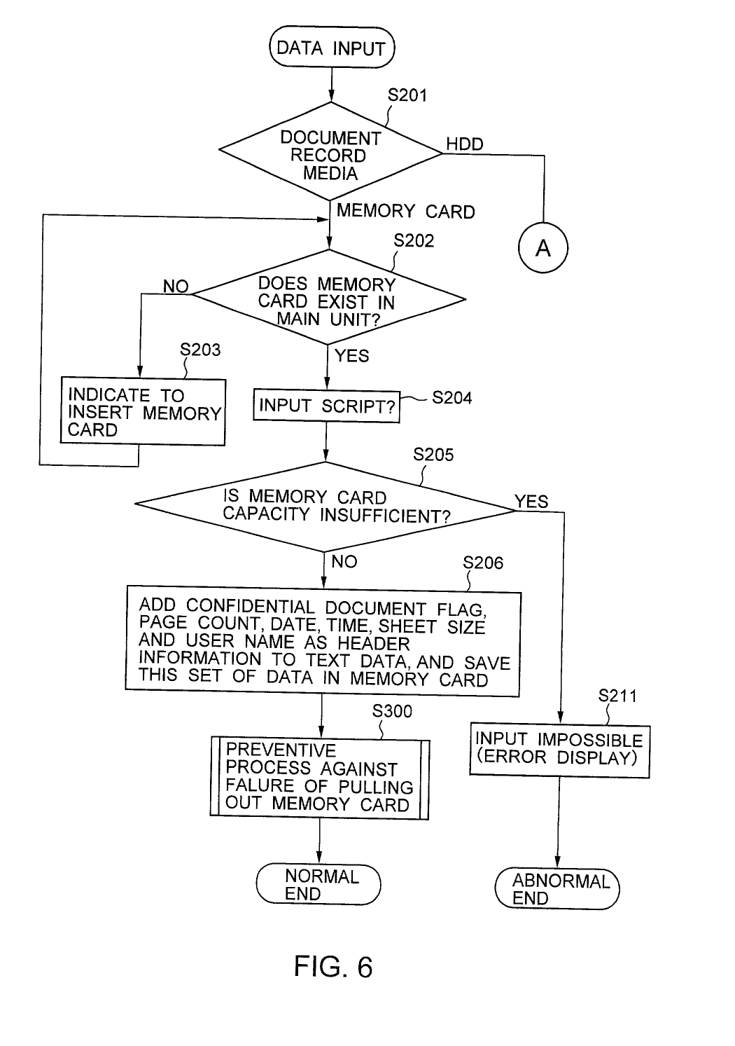

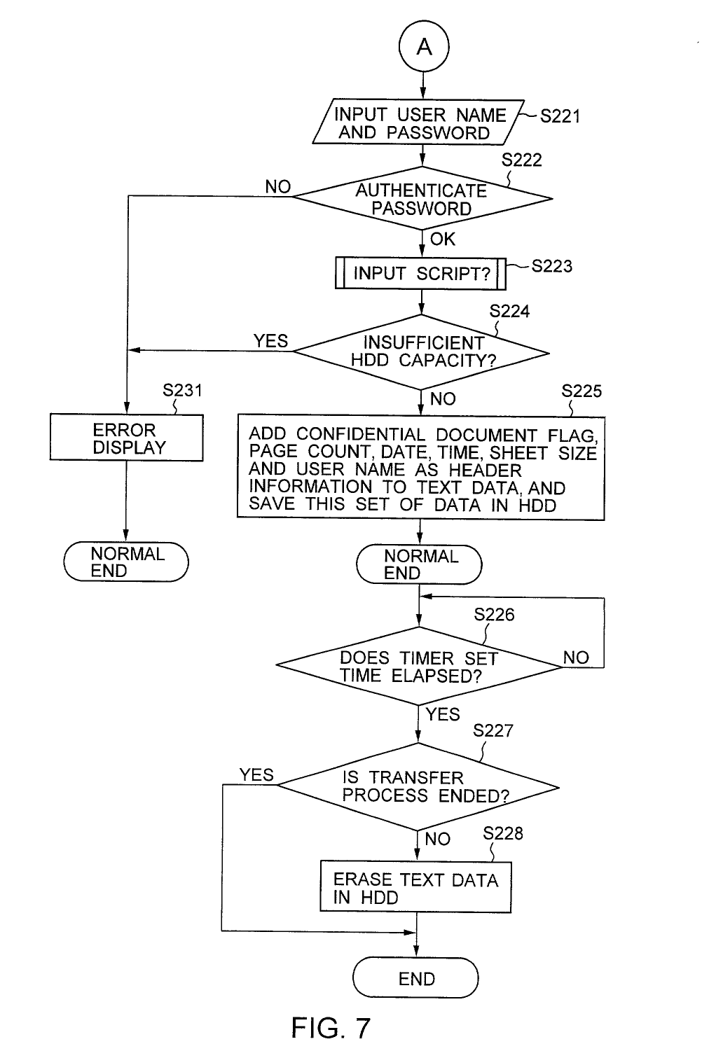

To start with, a case of selecting the confidential document input mode will be explained with reference to flowcharts in FIGS. 6 and 7.

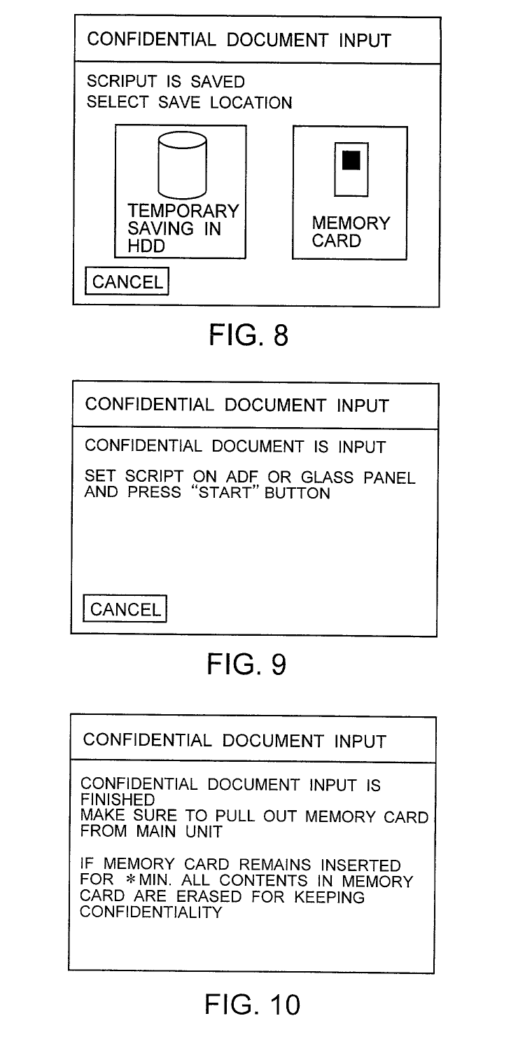

A screen (FIG. 8) for selecting recording mediums for recording the document are at first displayed, and one of these mediums is selected (step S201). The confidential document is in principle stored in the memory card because of its being confidential. If the memory card is not kept available as the case may be, however, the confidential document may also be temporarily stored in the HDD.

If the memory card is selected, it is judged whether the memory card is inserted into the main unit (step S202). If not yet inserted into the main unit, an indication of prompting the user to insert the memory card into the main unit, is given on the screen (step S203).

When judging that a get-ready state of the memory card is settled, a screen for prompting the user to input the confidential document is displayed as shown in FIG. 9, then the script is set on an ADF or a glass panel in response to this prompt, and an image scan is started by pressing a start button (step S204).

When transferring the readout data of the inputted document of the script to the memory card, an unused capacity of the memory card is checked (step S205). If the capacity of the memory card is insufficient, an error message is displayed (step S211), resulting in an end with a trouble that makes the input process unable to continue.

If the capacity of the memory card is large enough to store the data, a confidential document flag (i) indicating whether confidential or not, a storage date/time (ii), a document page count (iii), a document sheet size (iv) and a recorded user name (v), are added as header information to the save document data, and this document data suite is stored in the memory card (step S206). At this time, a screen shown in FIG. 10 is displayed to notify that the input of the confidential document is finished, and there is given an indication of pulling the memory card out of the main unit. Note that it must be user-friendly to automatically create a file name.

Hereafter, a process to prevent against failure of pulling out the memory card which will hereinafter be explained in depth, is executed (step S300), and the processing ends up with normality.

Note that when the memory card is kept inserted, this insertion is detected, and it may be automatically set to a confidential document mode that will be described later on. In this confidential document mode, the normal auto-clear, all-clear and so on are not conducted, and the screen display does not return to a normal copy screen unless a mode cancellation is executed.

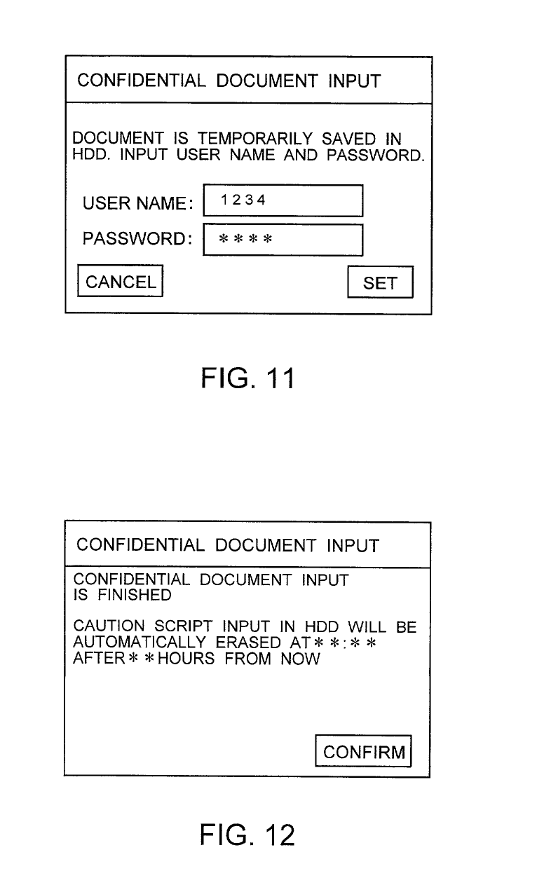

On the other hand, when the HDD is selected as a temporary storage medium, an input screen for inputting the user name and the password is displayed as shown in FIG. 11. The user name and the password are, when inputted (step S221), authenticated by checking whether the user name and the password are coincident with those registered beforehand (step S222). Therefore, the user information and the password stored in the non-volatile memory are read therefrom and compared with those inputted afresh. If coincident with each other, the processing may proceed to a next script inputting step. Whereas if impossible of identifying the user with the registered user as a result of authentication of the password, an error message is displayed (step S231), and the inputting process becomes impossible, resulting in an end with a trouble.

If the password is authenticated, the screen for prompting the user to input the confidential document is displayed as shown in FIG. 9, then the script is set on the ADF or the glass panel in response to this prompt, and then image scan is started by pressing the start button (step S223).

When transferring the readout data of the inputted document of the script to the HHD, an unused capacity of the HHD is checked (step S224). If the capacity of the HHD is insufficient, an error message is displayed (step S231), resulting in an end with a trouble that makes the input process unable to continue. If the capacity of the HDD is large enough to store the data, the confidential document flag (i) indicating whether confidential or not, the storage date/time (ii), the document page count (iii), the document sheet size (iv) and the recorded user name (v), are added as header information to the save document data, and this document data suite is stored in the HDD (step S225).

Thus, when finishing the storing on the HFD, though normally ended, a screen shown in FIG. 12 is displayed, and it is declared that the data are stored temporarily and, after a predetermined set time has elapsed, automatically erased. This is because, as will be mentioned later on, the storing on the HDD does not have a function more than temporary, and the HDD is just a location from which the contents stored are transferred to the memory card prepared.

Hence, it is monitored whether the set time has elapsed since a storage ending time (step S226). On condition that the transfer process to the memory disk is not yet completed after the set time has been elapsed (step S227), this set of stored data are erased (step S228).

This temporarily set storage time is determined in consideration of a time for the user to fetch the memory card, and for instance, 10 min, 15 min, 20 min and 30 min are selected. Under a specified condition, however, the temporary storage time can be extended. The specified condition given herein implies executing such a process that when the user inputs the text data to the memory card from the HDD, an error occurs due to a deficiency in the unused capacity of the memory card, and, if a remaining time possible of temporarily storing the document is small at that point of time, a measure for preventing the text data from being deleted just when the user exchanges the memory card and transfers again the document to the memory card from the HDD in a way that extends the temporarily storable time. This process will be described later on.

Note that the non-volatile memory is stored with a time (a) for the temporary storage, a time (b) for extending the temporary storage time under the specified condition, and the user name/password (c) needed when transferring the text data to the memory cared. Among these items, the user name/passwword (c) is set by the user as described above, however, the times (a) and (b) are preset by the administrator.

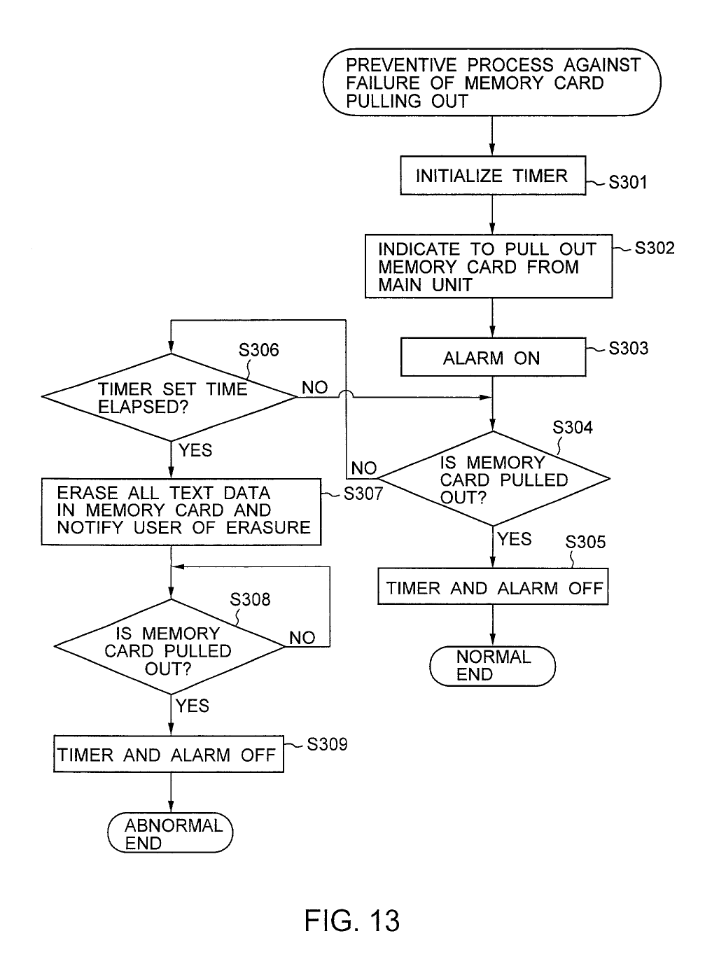

FIG. 13 is a flowchart showing the preventive routine against failure to pulling out the memory card described above,

To begin with, a timer is initialized (step S301), and a request for pulling out the memory card shown in FIG. 10 is displayed (step S302). Herein, if there elapses a predetermined preset time, i.e., a time till the data in the memory card are deleted for keeping the confidentiality, an alarm to be given is that all the contents in the memory card might be erased. Further, a chime as the alarm device is set in a standby state (step S303). A bell may also be used as a substitute for the chime. Moreover, the time till the data in the memory card are erased is set by the administrator and stored in the non-volatile memory 2 within the system. Further, the time till the data in the memory card are erased is set on the order of 10 sec. through within 1 min. in terms of speeding up the pull-out of the memory card.

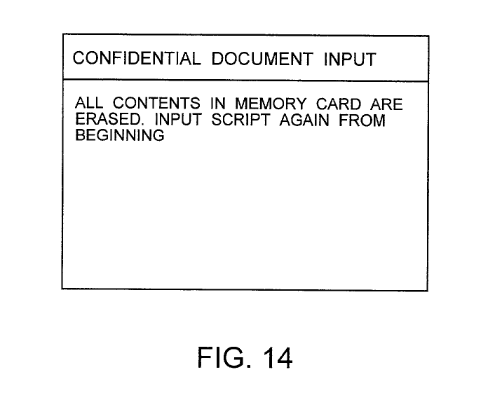

Next, it is monitored whether the memory card is pulled out (step S304). If pulled out, both of the timer and the alarm are set OFF (step S305), and the operation comes to an end. Note that the chime starts sounding upon a completion of storing on the memory card and continues to sound till the pull-out of the memory card is finished. This helps the user be aware of not pulling out the memory card. If absent, however, the set time of the timer elapses without pulling out the memory card. In this case (step S306), all the text data in the memory card are erased, and a message as shown in FIG. 14 is displayed for notifying the user of the data erase (step S307).

It is further monitored whether the memory card is pulled (step S308). If pulled out, the timer and the alarm are released from their operations (step S309).

Note that if the memory card is not pulled out, all of the copying, printing and image-scanning processes can be made impossible to perform in order to make the user aware of the memory card not being pulled out.

In this embodiment, in the case of saving the text data in the memory card, though not set to input the password, the saving may be permitted by authenticating the password. In this respect, it is desirable for keeping the user-friendliness that the input of the password is not needed, however, there are a variety of thinking ways about keeping the confidentiality, and hence it is optional that the administrator administers the password that way with his/her responsibility.

Similarly, the password may also be inputted when pulling out the memory card, and the password related to the memory card may also be set different from the password used for storing on the HDD.

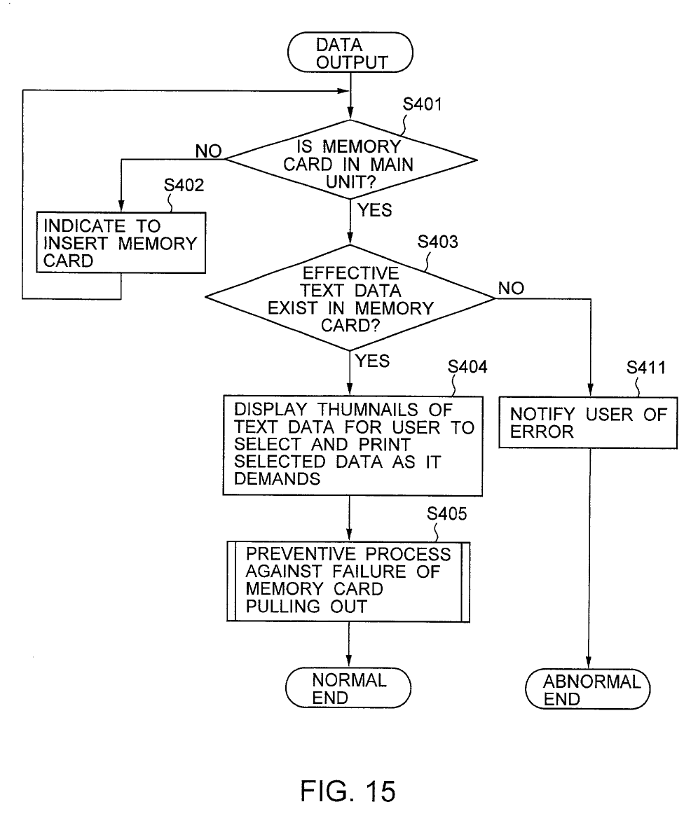

FIG. 15 is an explanatory flowchart showing a process of outputting the confidential text data.

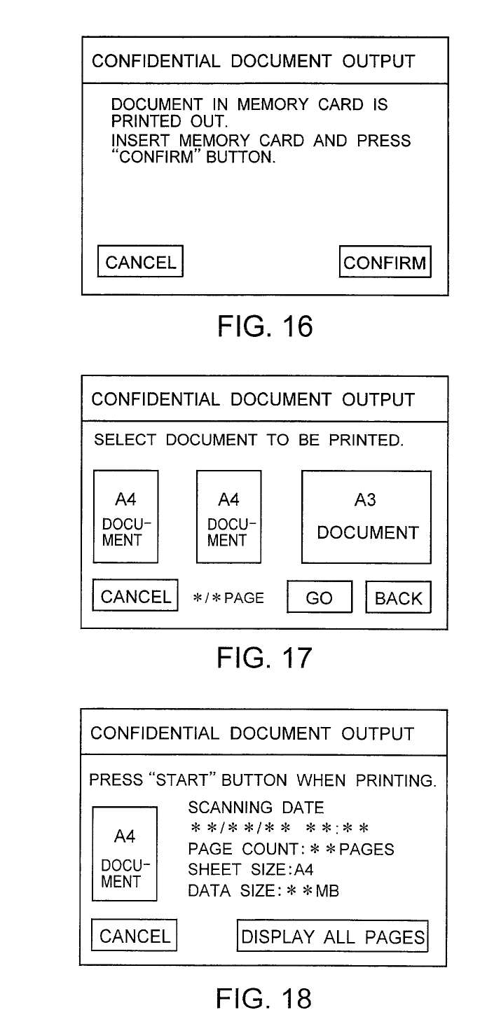

According to the image forming apparatus of the present invention, a print-output of the confidential document can be done only from the memory card. This being the case, it is at first confirmed whether the memory card is set in the main unit (step S401). If not set, a message for prompting the user to insert the memory card is displayed on the screen as shown in FIG. 16 (step S402).

If the memory card is set, it is further checked whether the effective text data are stored in the memory card (step S403). If no such data exits, a message for notifying the user of an error is displayed (step S411), resulting in an end with the trouble.

Whereas if the effective text data exist in the memory card, thumbnails (image sampled in small version) of the documents are displayed as shown in FIG. 17 (step S404). A typical example of the thumbnail display may be a display mode in which the first pages of the respective documents or some portions thereof are displayed in arrangement on the screen. When a print document is selected on this screen, detailed data of this document are displayed as shown in FIG. 18. When a start button (unillustrated) on the operation panel is pressed, the text data are transmitted to the printer 7 via the memory card reading device 5 and the buffer memory 4, and printed therein.

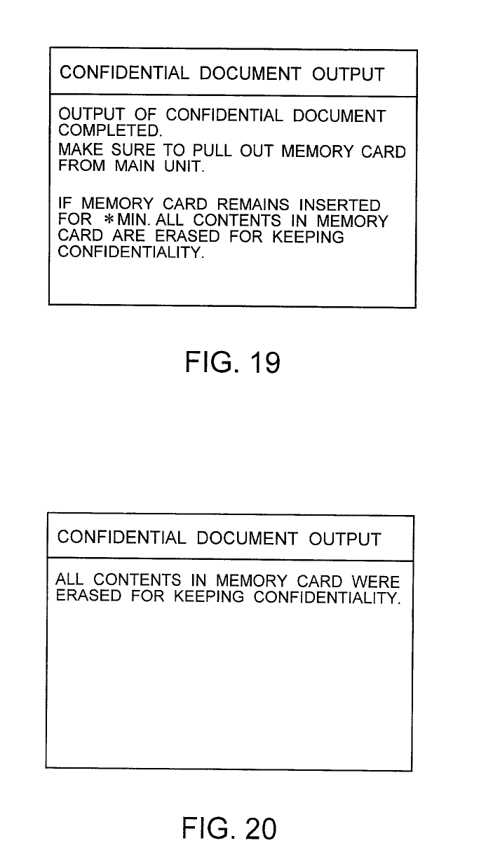

After an end of printing, a message shown in FIG. 19 is displayed, and the same process to prevent against failure of pulling out the memory card as that explained in FIG. 13 is executed (step S405). If the memory card is not pulled out for a set time, however, in case the contents in the memory card are erased, a message shown in FIG. 20 is displayed. Unlike the case shown in FIG. 14, there is no message for prompting the user to input from the script.

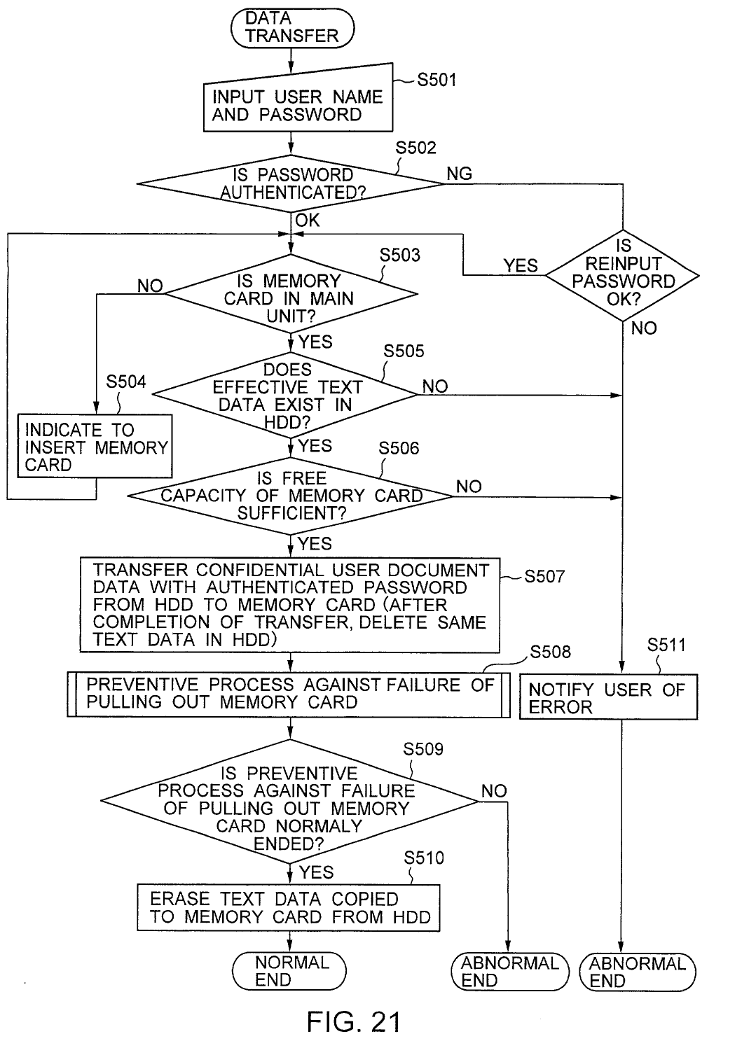

FIG. 21 is an explanatory flowchart showing a confidential document transfer process.

As discussed above, according to the image forming apparatus of the present invention, the storing on the HDD does not have the function more than temporary. The print-output can not be given from the HDD but can be given only from the memory card, and it is therefore required that the document be transferred to the memory card from the HDD.

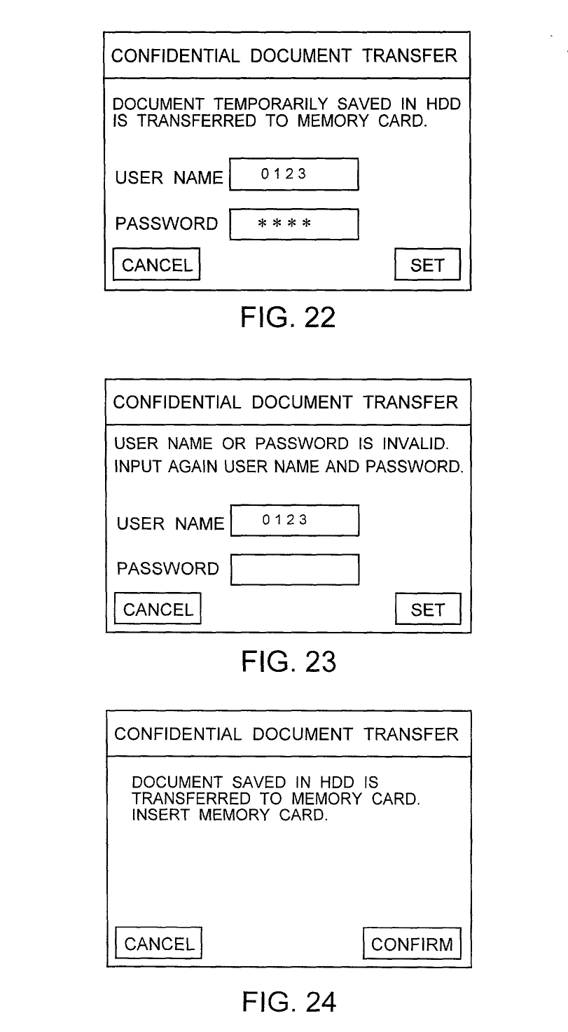

To begin with, the user name and the password needed for accessing the HDD are inputted to the input boxes on the screen shown in FIG. 22 (step S501).

The inputted user name and password are compared with those stored beforehand in the non-volatile memory 2, thus executing a password authentication process (step S502). If not coincident, a message for prompting the user to input again the user name and the password is displayed on the screen as shown in FIG. 23. If the re-inputted user name and password are different from those registered, a message for notifying the user of an error is displayed (step S511), resulting in an end with the trouble.

If a validity of the password is authenticated, it is next confirmed whether the memory card has already been set in the main unit (step S503). If not set, a message for prompting the user to insert the memory card is displayed as shown in FIG. 24 (step S504).

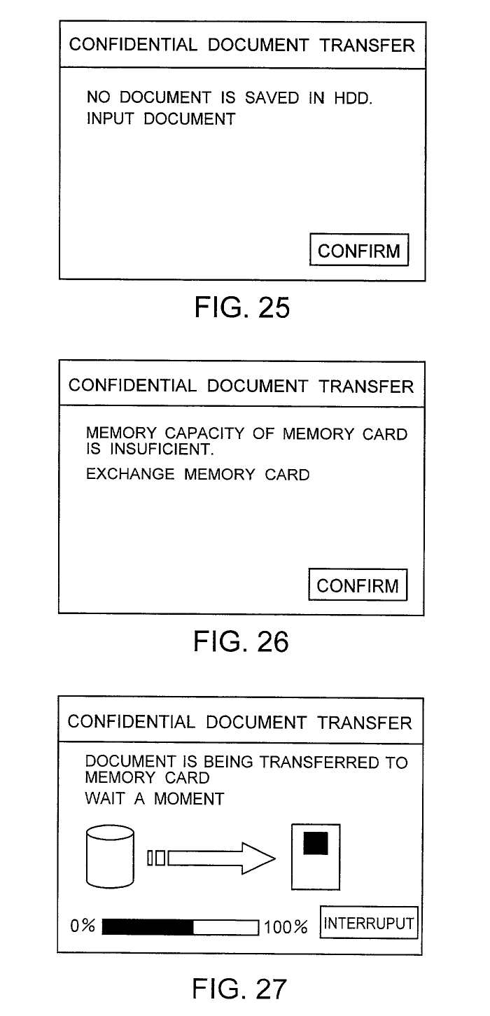

Next, it is confirmed whether the effective text data exist in the HDD (step S505). If the effective text data do not exist, as shown in FIG. 25, a message for notifying the user of an occurrence of error (step S511), resulting in an end with the trouble. Note that the no-existence of the data in the HDD may be exemplified by two cases where nothing is stored from the beginning, and where the data are, though temporarily stored, erased as the temporary storage time elapses.

When the effective text data exist in the HDD, it is confirmed whether the memory card has a sufficient free capacity (step S506). If the capacity of the memory card is insufficient for a data size of the save document, as shown in FIG. 26, a message for notifying the user of the occurrence of error is displayed (step S511), resulting in an end with the trouble.

If the memory card has a sufficient capacity, the text data of the confidential document of the user of which the password has been authenticated, are copied to the memory card from the HDD (step S507).

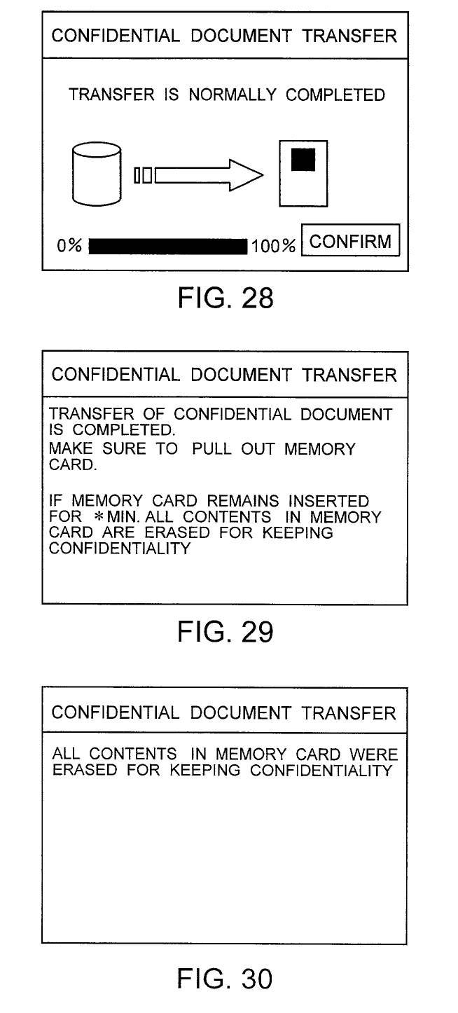

At this time, as shown in FIG. 27, a progress of the data transfer is displayed in a mode that sequentially indicates a transfer stage by percentage. As shown in FIG. 28, when the transfer stage shows 100%, this indicates a completion of the transfer.

Subsequently, a message shown in FIG. 29 is displayed, and the process to prevent against failure of pulling out the memory card is executed (step S508). A content of this process is the same as what has been explained in FIG. 13, however, a message coming out when the contents in the memory card have been erased with the elapse of the set time, is displayed as shown in FIG. 30.

If the process to prevent against failure of pulling out the memory card is normally ended, i.e., when the memory card is pulled out within the set time (step S509), the text data transferred to the memory card are completely erased from the HDD (step S510). Whereas if the process to prevent against failure of pulling out the memory card ends up with a trouble, however, the document in the HDD is not deleted.

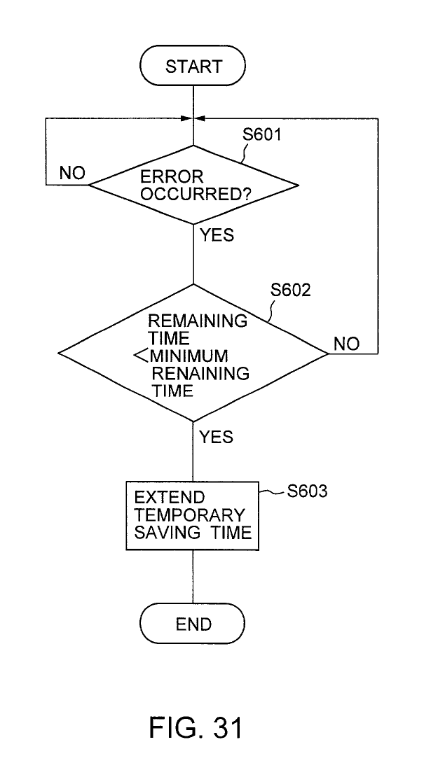

FIG. 31 is a flowchart showing a case in which an error occurs during the transfer of the text data to the memory card. This process may be defined as a subroutine of step S507 in FIG. 21.

If the error occurs during the transfer from the HDD to the memory card (step S601), a remaining time of the temporary storage time when the HDD temporarily stores the text data, is compared with a minimum remaining time (step S601). If smaller than this minimum remaining time, a time till the data are erased is extended (step S603). The minimum remaining time given herein is a time shorter than the temporary storage time but long enough to preparing a new memory card. Further, the time to be extended may be a difference between the minimum remaining time and the present remaining time or may be a normal temporary storage time. For example, if the normal temporary storage time is assumed to be 20 min., the minimum remaining time is 10 min. If the remaining time is less than this period of time, a difference between 20 min. and the remaining time may be set as an extension time.

When making a retry with the exchanged memory card inserted by executing such a process executed, a contrivance is that the text data are automatically erased with the passage of the temporary storage time of the HDD.

In the explanations of displays made so far, it is common that screen display returns to the copy menu upon pressing a [cancel] button.

Further, in the discussion given above, the HDD has been exemplified as the internal storage device, and the memory card reading/writing device has been exemplified as the external storage device. However, the internal storage device can be applied to all types of storage devices structured not to take in and out the medium, and the external storage device can also be applied all types of storage devices structured to take in and out the mediums.

As discussed above, according to the present invention, when saving the confidential data in the memory card, even if the memory card is not kept available, the data can be temporarily stored. It is therefore feasible to save the text data even if incapable of saving the data in the memory card due to the deficiency in the free capacity of the memory card and if the memory card is not brought in, further, it is possible to prevent the user from failing to pull out the memory card, and even if failing to pull out, there decreases a possibility of a leak-out of the information from within the memory card.

What is claimed is:

1. An image forming apparatus comprising:
a scanner unit for obtaining text data by scanning a document;
an external storage device for, if the text data obtained by said scanner unit are confidential, saving the confidential text data on an attachable/detachable medium;
an internal storage device for temporarily saving the confidential text data;
a device for deleting the confidential text data after a first predetermined time has elapsed since a point of time when the confidential text data were temporarily saved on said internal storage device; and
a control unit for controlling the whole of said image forming apparatus.

2. An image forming apparatus according to claim 1, wherein said external storage device saves the confidential text data given from said scanner unit, or saves the confidential text data stored on said internal storage device and transferred to said external storage device itself, and is controlled so that the confidential text data on said internal storage device are erased after a completion of the data transfer.

3. An image forming apparatus according to claim 2, wherein when said external storage device saves on said storage medium the confidential text data transferred from said scanner unit or from said internal storage device to said external storage device itself, contents stored on said storage medium are erased after a second predetermined time has elapsed.

4. An image forming apparatus according to claim 3, wherein said control unit, after a completion of saving the confidential text data on said storage medium, output a piece of information for prompting a user to pull out said storage medium.

5. An image forming apparatus according to claim 4, wherein the information for prompting the user to pull out said storage medium is at least one of a message displayed on a screen and a voice (sound) alarm.

6. An image forming apparatus according to claim 1, further comprising an operation unit for specifying, if the document to be deal with exhibits a high confidentiality, a confidential document mode.

7. An image forming apparatus according to claim 1, wherein said control unit, when temporarily saving the confidential text data on said internal storage device, executes an authentication process of comparing a user name and a password inputted with a user name and a password registered beforehand.

8. An image forming apparatus comprising:
a scanner unit for obtaining text data by scanning a document;
an external storage device for, if the text data obtained by said scanner unit are confidential, saving the confidential text data on an attachable/detachable medium;
an internal storage device for temporarily saving the confidential text data;
a password registration module for registering a user name and a password; and
a control unit for temporarily saving the confidential text data on said internal storage device, permitting a transfer of the temporarily saved confidential text data to said external storage device on condition that the password inputted by a user is coincident with a password registered in said password registration module, erasing contents stored on said internal storage device after a first predetermined time has elapsed since the confidential text data were temporarily saved, and erasing contents stored on said medium if said medium is not pulled out within a second predetermined time after transferring the confidential text data.

9. An image forming apparatus according to claim 8, wherein said control unit, if unused capacity of said medium becomes insufficient when transferring the confidential text data to said external storage device from said internal storage device, prevents the confidential text data from being erased by extending, even if a remaining time of the first predetermined time is small, this period of remaining time.

10. An image forming apparatus according to claim 9, wherein said control unit further emits a voice (sound) signal for prompting the user to pull out said medium from a point of time when completing the transfer of the confidential text data temporarily stored on said internal storage device to said external storage device.

11. A text data handling method in an image forming apparatus, comprising:
a step of obtaining text data by scanning a document with a scanner unit;
a step of, if the text data obtained by said scanner unit are confidential, temporarily storing the confidential text data on an internal storage device;
a step of transferring and saving an attachable/detachable medium with the confidential text data stored on said internal storage device through said external storage device;
a step of erasing contents stored on said internal storage device after transferring and saving the confidential text data to and on said medium; and
a step of executing a process for prompting a user to pull out said medium out of said external storage device.

12. A text data handling method in an image forming apparatus according to claim 11, further comprising a step of erasing the confidential text data temporarily stored on said internal storage device after a first predetermined time has elapsed since the confidential text data were stored.

13. A text data handling method in an image forming apparatus according to claim 12, further comprising a step of erasing the confidential text data stored on said medium after a second predetermined time has elapsed since the confidential text data were transferred to and saved on said medium from said scanner unit or said internal storage device.

14. A text data handling method in an image forming apparatus according to claim 11, wherein said step of executing the process for prompting the user to pull out said medium from said external storage device, involves at least one of displaying a message on a screen and giving a voice (sound) alarm.

15. A text data handling method in an image forming apparatus according to claim 11, wherein an operation unit specifies, if the document to be deal with exhibits a high confidentiality, a confidential document mode.

16. A text data handling method in an image forming apparatus according to claim 15, further comprising a step of executing an authentication process of comparing, if the confidential document mode is specified and when temporarily saving the confidential text data on said internal storage device, a user name and a password inputted with a user name and a password registered beforehand.
